(19) United States
(12) Patent Application Publication
(10) Pub. No.: US 2010/0083371 A1
(43) Pub. Date: Apr. 1, 2010

(54) User Access Control System And Method

(76) Inventors: Christopher Lee Bennetts, Hsin Tien City (TW); Christopher W. Larsen, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/243,126

(22) Filed: Oct. 1, 2008

(51) Int. Cl. H04L 9/32; G06F 21/00

(52) U.S. Cl. 726/19

(57) ABSTRACT

A user access control system, comprising an electronic device comprising an electronic device comprising a reduced function operating system configured to enable access to at least one type of media content and a content control module executable by the reduced function operating system, the content control module configured to authenticate an identity of a user and control access to the at least one type of media content based on the identity of the user.

### BACKGROUND

Electronic devices typically include parental control features to enable a parent to limit a child user's access to various content and/or devices compatible with the electronic device. However, the parental control features are generally difficult to set, and different sets of ratings for different types of content increases the complexity of the task.

### BRIEF DESCRIPTION OF THE DRAWINGS

FIG. 1 illustrates an embodiment of an access control system for a portable electronic device;

FIG. 2 is a block diagram depicting an embodiment of the access control system of FIG. 1;

FIG. 3 illustrates an embodiment of a graphical user interface (GUI) used to create and/or modify a user profile for the access control system of FIGS. 1 and 2;

FIG. 4 illustrates an embodiment of a ratings map for the access control system of FIGS. 1 and 2; and

FIG. 5 is a flow chart illustrating an embodiment of a user access control method.

### DETAILED DESCRIPTION OF THE DRAWINGS

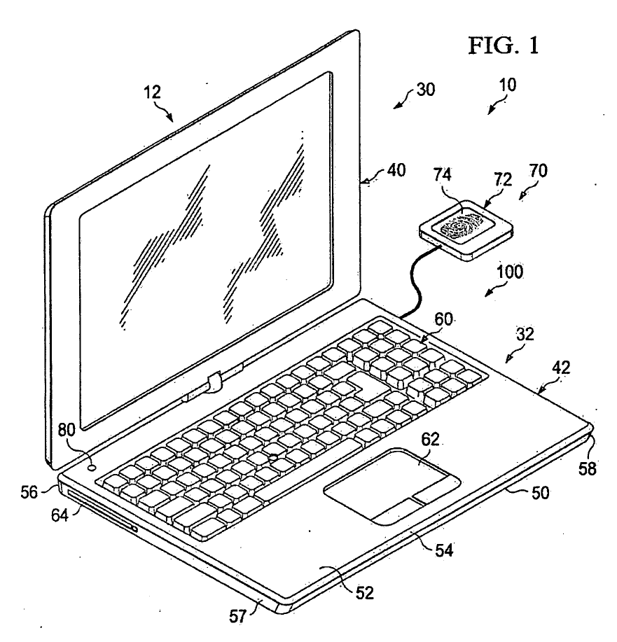

FIG. 1 illustrates an embodiment of an access control system 100 for a electronic device 10. Access control system 100 enables a user to manage and/or control access to media content presentable on electronic device 10. For example, in some embodiments, system 100 establishes and/or defines a profile for each user in a profile system which identifies a content access level setting for each user of electronic device 10. In FIG. 1, electronic device 10 comprises a laptop or notebook computer 12. However, it should be understood that electronic device 10 can be any type of portable and/or non-portable electronic device such as, but not limited to, a desktop computer, a tablet computer, a personal digital assistant (PDA), a cellular phone, and a television.

In the illustrated embodiment, electronic device 10 comprises a display member 30 rotably coupled to a base member 32. Display member 30 and base member 32 each comprise housings 40 and 42, respectively, for housing and/or supporting one or more components of electronic device 10. For example, in the illustrated embodiment, housing 42 of base member 32 comprises a bottom wall 50, a working surface 52, a front wall 54, a back wall 56, and side walls 57 and 58. In FIG. 1, working surface 52 comprises a keyboard 60 and a touchpad 62. However, it should be understood that working surface 52 may comprise more or fewer components and/or devices than illustrated. In FIG. 1, base member 32 also comprises interfaces for various user interface components disposed along any of working surface 52 and walls 50, 54, 56, 57 and 58. For example, in FIG. 1, disposed along side wall 57, base member 32 comprises an optical drive 64 for receiving various optical media (e.g., a digital video disc (DVD), a compact disc (CD), etc.). It should be understood, however, that optical drive 64 may be disposed along any of walls 50, 52, 54, 56 and 58 of base member 32 and/or may be located elsewhere on electronic device 10 (e.g., in display member 30) and may also be a peripheral device externally coupled to one of the interfaces of electronic device 10.

In some embodiments, system 100 comprises authentication device 70. In some embodiments, authentication device 70 comprises a biometric authentication device 72 used to biometrically verify the identity of a user requesting access to electronic device 10. In FIG. 1, biometric authentication device 72 is a fingerprint reader 74; however, it should be understood that biometric authentication device 72 may be any type of biometric device including, but not limited to, an optical recognition system, a facial recognition system, and a voice recognition system. In the illustrated embodiment, biometric authentication device 72 is externally coupled to electronic device 10; however, it should be understood that biometric authentication device 72 may also be disposed anywhere on base member 32 or display member 30.

In some embodiments, system 100 comprises a reduced function operating system (OS) button 80 configured to load and/or initialize a reduced function OS. A reduced function OS is an operating system providing a limited number of resources and/or functions as compared to a normal or full function OS. In some embodiments, a reduced function OS boots and/or loads in less time than full function OS, thereby facilitating quick access to various devices interfacing with electronic device 10 (e.g., optical media drive 64). In FIG. 1, reduced function OS button 80 is disposed on working surface 52 along an edge proximate to display member 30. However, it should be understood that reduced function OS button 80 may be disposed along any of walls 50, 52, 54, 56 and 58 of base member 32 and/or may be located elsewhere on electronic device 10 (e.g., in display member 30). In some embodiments, reduced function OS button 80 may be identified by the letter “i;” however, it should be understood that reduced function OS button 80 may be otherwise identified (e.g., labeled “reduced function OS button,” etc.).

Thus, in operation, electronic device 10 initializes in response to the selection and/or pressing of reduced function OS button 80. Electronic device 10 boots and/or loads a reduced function OS. The reduced function OS executes an authentication protocol configured to verify and/or authenticate confirmation of a user's identity. In some embodiments, electronic device 10 requests a user to place a finger on fingerprint reader 74 to verify the user's identity. In some embodiments, electronic device 10 requests a user to input another authentication means (e.g., typing in a user name and password combination, etc.). Based on the identification of the user, the reduced function OS executes a profile management system to identify the user's profile. In some embodiments, the user's profile indicates a content access level setting for media content received by electronic device 10. Electronic device 10 applies the user's profile, thereby blocking, filtering, and/or unblocking media content accessible to the user on electronic device 10 based on the user's profile.

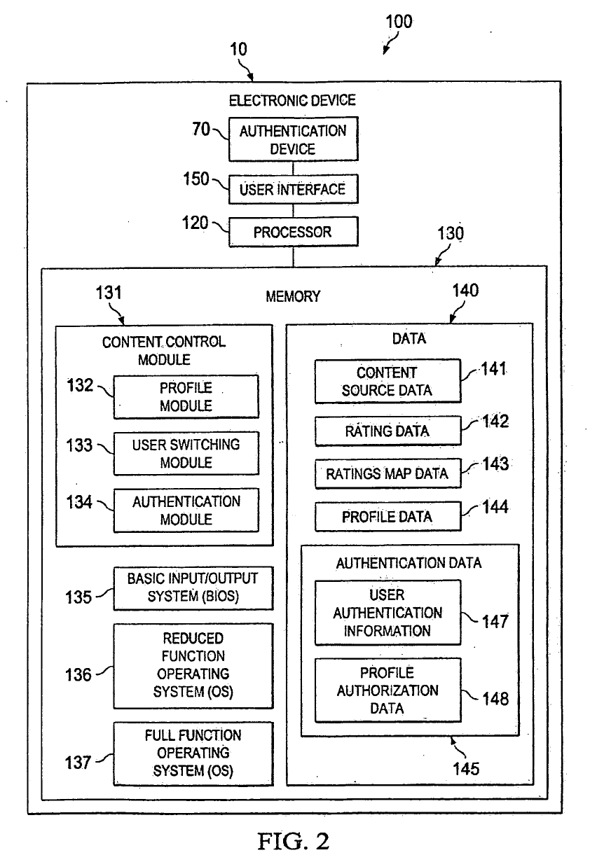

FIG. 2 is a block diagram depicting an embodiment of access control system 100 of FIG. 1. In FIG. 2, system 100 comprises a processor 120, a memory 130, a user interface 150, and authentication device 70. Components of system 100 may comprise a software-only embodiment, a hardware-only embodiment, or a software and hardware combined embodiment. In the illustrated embodiment, memory 130 comprises a content control module 131, a basic input/output system (BIOS) 135, a reduced function operating system (OS) 136, a full function OS 137, and data 140. As indicated above, reduced function OS 136 is an operating system providing a limited number of resources and/or functions as compared to a normal or full function OS 137. As a result, reduced function OS 136 boots and/or loads in less time than full function OS 137, thereby facilitating quick access to various devices interfacing with electronic device 10 (e.g., optical media drive 64 of FIG. 1). In some embodiments, memory 130 comprises a shared memory space having reduced function OS 136 disposed in one partition of memory 54 and full function OS 137 disposed in another partition of memory 54. However, it should be understood that memory 130 may be otherwise separated and/or partitioned to include reduced function OS 136 and full function OS 137.

In FIG. 2, content control module 131 is illustrated as being stored in memory 130 so as to be accessible and/or executable by processor 120. However, it should be understood that a portion and/or all of content control module 131 may be otherwise stored (e.g., in an external memory). Content control module 131 comprises a profile module 132, a user switching module 134, and an authentication module 136. In some embodiments, profile module 132 is configured to enable a user (e.g., a parent) to establish and/or define a user profile for a number of different users and manage and/or control access to media content based on the user profile. The user profiles defined by profile module 132 identify a content access level setting for each user of electronic device 10. A content access level setting is setting that identifies the level and/or amount of media content accessible by the user. In some embodiments, the content access level setting is based on a rating system (e.g., “G,” “PG,” “R,” etc.). In some embodiments, the content access level setting is an access or no access system.

In some embodiments, profile module 132 enables a user to establish a different content access level setting for each user for media content received from a number of different content sources. A “content source” as used herein is any component, device, and/or software element configured to provide media content to electronic device 10 for viewing and/or using on electronic device 10. For example, a content source can be, but not limited to, a digital video recorder (DVR), a digital video disc (DVD) player, a television set, a radio, a karaoke device, the internet, and a gaming device. “Media content” provided by the content source can be any type of media content, including, but not limited to, a movie, a television program, a song, a webpage, a software program, full function operating system 137, and a game.

User switching module 134 enables electronic device 10 to dynamically change and/or adjust the amount of accessible media content presentable on electronic device 10 in response to authentication of a user on electronic device 10. In some embodiments, user switching module 134 filters, blocks, and/or unblocks media content access based on the content access level setting for the user requesting access. In some embodiments, user switching module 134 enables electronic device 10 to change users without a current user exiting and/or logging off of electronic device 10. Thus, in this embodiment, user switching module 134 automatically changes and/or adjusts the amount of accessible media content in response to an authentication of a user requesting access to electronic device 10. Authentication module 136 authenticates and/or verifies the identification of a user requesting access to media content via electronic device 10. In some embodiments, authentication module 136 authenticates the user based on the entry of a user identification and corresponding password for the user. In some embodiments, authentication module 136 verifies the user using biometric authentication device 72 (e.g., a fingerprint recognition, optical recognition, voice recognition system, etc.) (FIG. 1).

In FIG. 2, data 140 comprises content source data 141, rating data 142, ratings map data 143, profile data 144, and authentication data 145. Components of data 140 may be stored and/or represented in any format including, but not limited to, a table, relational database an Extensible Markup Language (XML) database, a hash table, and a file. In FIG. 2, content source data 141 comprises data identifying all the content sources configured to present media content on electronic device 10. Rating data 142 comprises rating information corresponding to each of the types of media content provided by a particular content source. For example, rating data 142 for a movie may comprise the standard movie rating system (e.g., G, PG, PG-14, R, etc.). As another example, rating data 142 for a website may comprise a High, Medium, and Low rating system based on the amount of inappropriate media content for some users (e.g., nudity, violence, language, etc.) included on the website. In some embodiments, the High, Medium, and Low rating system may be based on the subject matter and/or type of information available on the website.

In FIG. 2, ratings map data 143 correlates a rating for one type of media content with the rating for another type of media content. For example, ratings map data 143 may correlate a movie rating of “G” with a television program rating of TVY. As another example, ratings map data 143 may correlate a games rating of “T” with a movies rating of “R.” In some embodiments, ratings map data 143 may be created and/or established by a user and/or administrator of electronic device 10. In some embodiments, ratings map data 143 is predetermined by a third party and stored as ratings map data 143. Profile data 144 comprises profile information for each user of electronic device 10. In some embodiments, profile data 144 comprises a content access level setting for each media content type for each user. In some embodiments, a content access level setting corresponds to a rating for a particular type of media content for a particular user. For example, a user may have a content access level setting of “PG13” for a movie and a content access level setting of “TVG” for television programs.

Authentication data 145 comprises information used by authentication module 136 to authenticate and/or verify the identity of a user requesting access to media content on electronic device 10. In FIG. 2, authentication data 145 comprises user authentication information 147 and profile authorization data 148. User authentication information 147 comprises user specific information (e.g., a user name and password, a fingerprint, an optical image, a facial image, a voice recording, etc.) used to identify the user profile for the user requesting access and/or limit the amount of accessible media content available to the user based on the user profile. The type of information stored in user authentication information 147 depends on the type of authentication device 70 (e.g., biometric authentication device 72, fingerprint reader 74 (FIG. 1), etc.) used by electronic device 10. Profile authorization data 148 comprises identification and/or authorization information for a user authorized to create and/or modify a profile for another user. In some embodiments, profile authorization data 148 may comprise the biometric information stored in biometric information 147 for the authorized user. In some embodiments, profile authorization data 148 may comprise a user name and password combination for the authorized user. It should be understood, however, that profile authorization data 148 comprise other types of identification and/or authorization information (e.g., a challenge question, etc.).

Thus, in operation, BIOS 135 launches reduced function OS 136 in response to a user selecting and/or pressing reduced function OS button 80. After reduced function OS 136 loads, reduced function OS 136 executes content control module 131 to identify and apply a user profile. Content control module 136 initially launches authentication module 134 to authenticate and/or verify the identity of the user. In some embodiments, authentication module 134 requests the user to enter authentication information. In some embodiments, a user enters biometric information (e.g., a fingerprint) into biometric authentication device 72. In some embodiments, a user enters a user name and/or password combination into either user interface 150 and/or authentication device 70. Authentication module 136 confirms and/or verifies the entered authentication information against the information stored in authentication data 145 to identify the user. Once the identity of the user is identified, content control module 136 executes profile module 132 to identify the content access level setting for each media content type and/or content source for the user based on the user's profile stored in profile data 144. Content control module then executes user switching module 134 to adjust the amount of media content accessible by the user based on the user profile and the content access level settings for the user. In some embodiments, a new user may request access to electronic device 10 while a current user is still using electronic device 10. In this embodiment, user switching module 134 logs the current user off of electronic device 10, and then logs in and/or loads the content access level settings for the new user. Profile module 132 then enables a user to access certain media content on user interface 150 based on the profile and the content access level settings for the user. In some embodiments, a users profile indicates that a user has access to full function operating system 137. In this embodiment, content control module 131 transmits a request to reduced function operating system 136 to initiate and/or load full function operating system 137. Once full function operating system 137 is loaded, the user has access to media content presented via operating system 137.

In some embodiments, reduced function OS 136 enables a user to create and/or modify a profile for at least one user of electronic device 10. In some embodiments, reduced function OS 136 launches full function OS 137 in response to a request to create and/or modify a profile for at least one user. In either embodiment, in response to the request, reduced function OS 136 and/or full function operating system 137 loads and/or executes content control module 131. Authentication module 136 determines and/or verifies that the requesting user has access to create and/or modify a profile for another user in electronic device 10. In some embodiments, authentication module 136 requests the requesting user to input authentication and/or verification information. In some embodiments, a user inputs biometric information into biometric authentication device 72. In some embodiments, a user inputs authentication and/or verification information (e.g., a user name and corresponding password) into user interface 150. Authentication module 136 then compares the input authentication and/or verification with the information stored in profile authorization data 148. If the input authentication information matches the information stored in profile authorization data 45 for the particular user, then authentication module 136 grants the requesting user access to the profile system.

Profile module 132 then presents a user interface 150 enabling the requesting user to establish and/or modify the profile for at least one user of electronic device 10. In some embodiments, if the profile for a particular user is already stored in profile data 144, profile module 44 presents the user profile (e.g., the stored content access level settings) on user interface 150. In some embodiments, profile module 44 presents a GUI enabling a new user profile to be established in the profile system. In some embodiments, profile module 44 references and/or reads the corresponding rating information stored in rating data 142 for each media content type corresponding to the user profile. In some embodiments, profile, module 44 then presents the other rating categories for the media content type to the user to enable the user to create and/or modify the profile for that particular media content type. In some embodiments, profile module 44 automatically populates the corresponding rating information based on the selection one of the media content types. For example, if a user selects a “PG” content access level setting for movies, then profile module 44 automatically populates the corresponding rating for all the other listed content sources (e.g., a television program, a song, a webpage, a software program, a game, etc.). The new and/or changed profile(s) is (are) then stored in profile database 40 for use when the corresponding user requests access to electronic device 10.

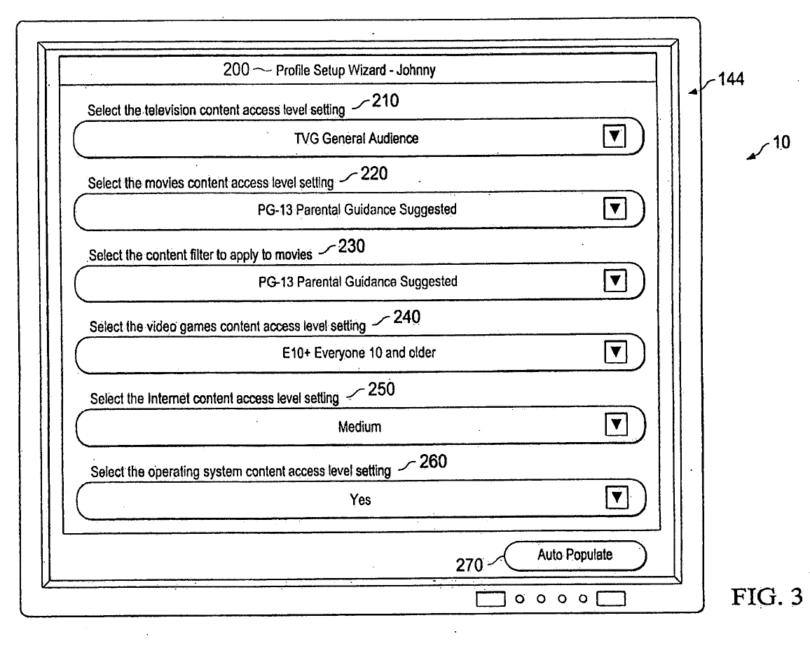

FIG. 3 illustrates an embodiment of a GUI 200 used to create and/or modify a user profile for media content received from a content source by electronic device 10. In FIG. 3, GUI 200 enables a user to establish, create, and/or modify the user profile data 244 for “Johnny.” Specifically, in FIG. 3, a content access level setting may be set for television content 210, movie content 220, a content filter 230 to apply to movies, games 240, internet 250, and an operating system 260. It should be understood, however, that GUI 200 may include more, fewer and/or different media content types than illustrated. Additionally, it should be understood that the media content illustrated in GUI 200 may originate from a number of different content sources.

In some embodiments, content filter 230 is a feature of electronic device 10 (FIGS. 1 and 2) that enables the filtering of movies presented by electronic device 10. Content filter 230 enables a user to identify unacceptable and/or undesirable media content to a particular user (e.g., profanity, graphic violence, etc.) that may be present in a movie. Content filter 230 identifies the portions of the movie with the specified undesirable media content so that when a particular user watches the movie, the identified portions of the movie are muted, skipped, fast forwarded and/or otherwise passed by. In some embodiments, internet content access level setting 250 restricts the amount and/or types of websites available to a user on electronic device 10 depending on the type of media content which would be presented on the website. In FIG. 2, internet content access level setting 250 is based on a “High, Medium, Low” rating scale, with “High” indicating a highest level of filtration and/or blocking and “Low” indicating the lowest level of filtration and/or blocking. In FIG. 2, operating system content access level setting 250 indicates whether a user has access to the operating system of electronic device 10. In FIG. 3, a user either has access (“Yes”) or does not have access (“No”).

In FIG. 3, GUI 200 comprises an auto populate button 270 configured to enable a user to automatically populate the content access level settings for “Johnny” based on the selection of one of the content access level settings. For example, in FIG. 3, a user sets television content access level setting 210 to “TVG General Audience” and then selects auto populate button 270. Based on ratings map data 143 (FIG. 2), profile module 132 (FIG. 2) then identifies the corresponding ratings for each of the remaining media content types (e.g., movie content 220, content filter 230, games 240, internet 250, operating system 260, etc.) and sets the content access level setting for each of the remaining media content types. In some embodiments, a user can select and/or identify the media content type to base the automatic population. In some embodiments, profile module 132 bases the automatic population off of the last changed content access level prior to the selection of auto populate button 270

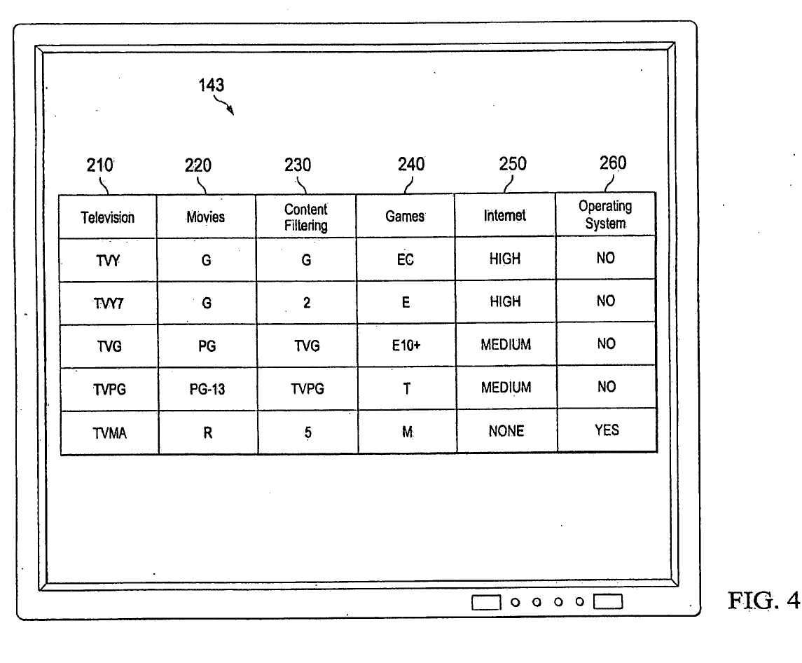

FIG. 4 illustrates an embodiment of ratings map data 143 for access control system 100 of FIGS. 1 and 2. Ratings map data 143 shows and/or correlates the rating system for one media content type to another media content type for use to automatically populate a profile for a specific user. For example, in FIG. 4, ratings, map data 143 depicts the corresponding and/or equivalent ratings for each of television content 210, movies content 220, content filter content 230, games content 240, internet content 250, and operating system content 260. For example, television content 210 rating of “TVY” correlates to a “G” movies content 220 rating, a “G” content filtering content 230 rating, an “EC” games content 240 rating, a “High” Internet content 250 rating, and “No” operating system content 260 rating. Thus, in use, when defining the content access level settings for each media content type for a user, profile module 132 (FIG. 2) use ratings map data 143 to automatically populate a profile for the user based on the corresponding rating for each media content type. It should be understood, however, that ratings map data 143 may include more, fewer, and/or different media content types and/or rating systems than illustrated.

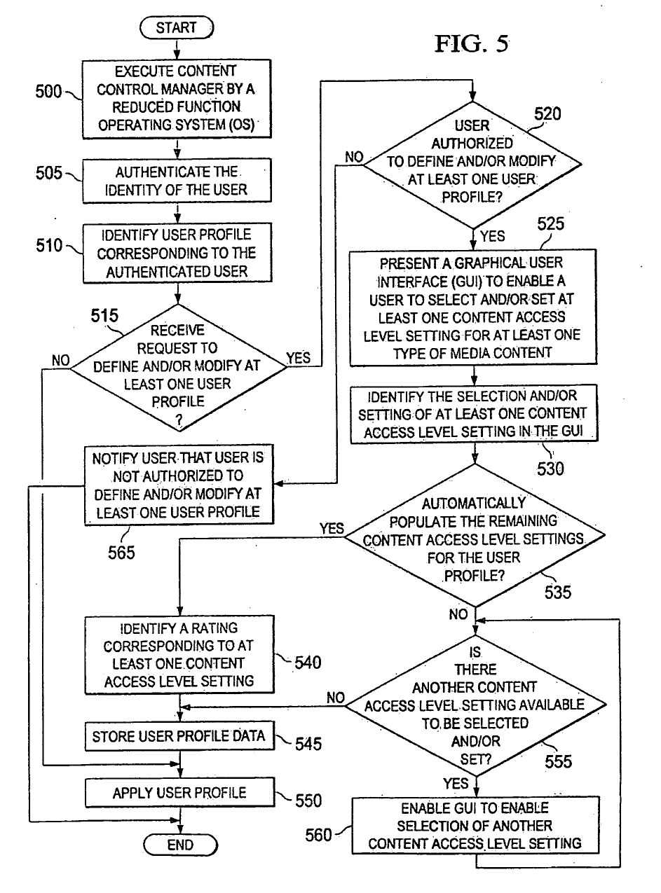

FIG. 5 is a flowchart illustrating an embodiment of a user access control method. The method begins at block 500 where reduced function OS 136 executes content control manager 131 in response to a selection of a reduced function OS button 80. Content control manager 131 then executes authentication module 134 to authenticate the identity of the user requesting access to reduced function OS 136 and/or electronic device 10 (block 505). In some embodiments, authentication module 134 references user authentication information 147 to verify the authentication information provided by the user. In some embodiments, authentication module 134 biometrically authenticates a user. In some embodiments, authentication module 134 authenticates a user using another method (e.g., a user name and password combination). Profile module 134 then identifies the user profile stored in profile data 144 which corresponds to the authenticated user (block 510).

Content control manager 131 then determines whether a request to define and/or modify at least one user profile has been made (decision block 515). If a request was made (“yes” output to decision block 515), then authentication module 134 references profile authorization data 148 to determine whether the user is authorized to define and/or modify at least one user profile (decision block 525). If the user is authorized (“yes” output to decision block 520), profile module 132 presents a graphical user interface (GUI) (e.g., GUI 200 (FIG. 3)) to enable a user to set a content access level setting for media content received by electronic device 10 from a number of content sources (block 525). In some embodiments, profile module 132 uses the information stored in content source data 141 to enable a user to set the content access level settings. Profile module 132 then identifies a selection and/or setting of at least one content access level setting in the GUI (block 530). Profile module 132 then determines whether to automatically populate the remaining content access level settings for the at least one user profile (decision block 535). In some embodiments, electronic device 10 comprises a button (e.g., auto populate button 270) enabling a user to request the automatic population of the remaining content access level settings. In response to a determination to automatically populate the remaining content access level settings (“yes” output to decision block 535), profile module 132 identifies the rating in ratings map data 143 corresponding and/or correlating to the at least one content access level setting (block 540). Profile module 132 stores the defined and/or modified user profile as profile data 144 (block 545). Profile module 132 then applies the user profile to electronic device 10 (block 550), with the method terminating thereafter.

Returning to decision block 535, profile module 132 determines whether another content access level setting in the user profile is available to be selected and/or set (decision block 555). If another content access level setting is available (“yes” output to decision block 555), profile module 132 enables the GUI to enable selection and/or setting of another content access level setting (block 560), with the method returning to decision block 555 thereafter. If another content access level setting is not available (“no” output to decision block 555), then the method returns to block 434 thereafter.

Returning to decision block 520, if a user is not authorized to define and/or modify at least one user profile (“no” output to decision block 520), then profile module 132 notifies the user that the user is not authorized (block 565), with the method terminating thereafter. Returning to decision block 515, if a request to define and/or modify at least one user profile is not made (“no” output to block 515), then content control module 131 applies the user profile corresponding to the authenticated user (block 550), with the method terminating thereafter.

The illustrative embodiments may be implemented in software and can be adapted to run on different platforms and operating systems. In particular, functions implemented by access control system 100, for example, may be provided by an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electro-magnetic, infrared, or semiconductor system, apparatus, device, or propagation medium.

Thus, the illustrative embodiments of access control system 100 enables a user (e.g., a parent) to control user (e.g., child) access to media content received from various content sources by electronic device 10. Embodiments of access control system 100 enable a user to control access to electronic device 10, including a full function OS 137. Embodiments of access control system 100 also enables a user to establish and/or define a profile for one or more users of electronic device 10 and the content access levels for a plurality of different types of electronics sources using a single graphical user interface (e.g., graphical user interface 200). Embodiments of access control system 100 further provide for a user switching module 134 which enables a user to quickly access media contents stored on electronic device 10 without having electronic device 10 logging completely out of full function OS 137 and/or electronic device 10.

What is claimed is:

1. A user access control system, comprising:
an electronic device comprising a reduced function operating system configured to enable access to at least one type of media content; and
a content control module executable by the reduced function operating system, the content control module configured to authenticate an identity of a user and control access to the at least one type of media content based on the identity of the user.

2. The system of claim 1, wherein the content control module is configured to disable access to at least one type of media content.

3. The system of claim 1, wherein the content control module is configured to control access to the at least one type of media content based on a content access level setting for the user.

4. The system of claim 1, wherein the content control module is configured to apply a ratings map associated with the user to determine accessible media content for the user.

5. The system of claim 1, wherein the content control module is configured to automatically populate a user profile for the user to automatically set a content access level setting for a plurality of different types of media content based on a content access level setting for one type of media content.

6. The system of claim 1, wherein the content control module is configured to dynamically filter the at least one type of media content based on the identity of the user.

7. The system of claim 1, wherein the content control module is configured to dynamically control access to the at least one type of media content in response to detecting a change in an identity of a user of the electronic device.

8. The system of claim 1, wherein the content control module biometrically authenticates the identity of the user.

9. A user access control system, comprising:
a biometric authentication device for authenticating an identity of a user, and
an electronic device having a content control module executable by a reduced function operating system, the content control module configured to control access to a full function operating system based on the identity of the user.

10. The system of claim 9, wherein the biometric authentication device comprises a fingerprint reader.

11. The system of claim 9, wherein the electronic device comprises a button configured to initialize the reduced function operating system.

12. The system of claim 9, wherein the content control module verifies a content access level setting for the user to control access to the full function operating system.

13. The system of claim 9, wherein the content control module is configured to control access to at least one type of media content based on the identity of the user.

14. A user access control method, comprising:
configuring a content control module to authenticate an identity of a user and, based on the identity of the user, control access to at least one type of media content presentable by an electronic device, the content control module executable by a reduced function operating system for the electronic device.

15. The method of claim 14, further comprising accessing the at least one type of media content based on the identity of the user.

16. The method of claim 14, further comprising filtering the at least one type of media content based on the identity of the user.

17. The method of claim 14, further comprising applying a ratings map which correlates a rating system for at least two different media content types for the identified user.

18. The method of claim 14, further comprising controlling access to a full function operating system of the electronic device based on the identity of the user.

19. The method of claim 14, further comprising dynamically adjusting access to the at least one type of media content in response to detecting a change in an identity of a user of the electronic device.

20. The method of claim 14, further comprising biometrically authenticating the identity of the user.
